(19) United States
(12) Patent Application Publication
(10) Pub. No.: US 2015/0296140 A1
(43) Pub. Date: Oct. 15, 2015

(54) Panoramic view blind spot eliminator system and method

(71) Applicant: Grey Matter Fusion, Inc., Wanaque, NJ (US)

(72) Inventor: Philos Kim, Wanaque, NJ (US)

(21) Appl. No.: 14/251,541

(22) Filed: Apr. 11, 2014

(51) Int. Cl. H04N 5/232; G06K 9/00

(52) U.S. Cl. CPC H04N 5/23238; G06K 9/00805

(57) ABSTRACT

A panoramic view system for eliminating blind spots in a vehicle includes: at least two video cameras, a panoramic screen, a panoramic controller, such that the panoramic screen shows a combined video stream from the video cameras, which provides a driver with a panoramic rear-view of the vehicle surroundings without any blind spots. The panoramic controller includes a processor, a non-transitory memory, an input/output, and a video manager. Also disclosed is a method for automotive panoramic viewing, including receiving video, combining video streams, and viewing a panoramic video stream.

### CROSS-REFERENCE TO RELATED APPLICATIONS

N/A

### FIELD OF THE INVENTION

The present invention relates generally to the field of rear-vision systems and devices for use on automobiles and other vehicles.

### BACKGROUND OF THE INVENTION

Current methods of determining what vehicles and other objects are in the immediate vicinity during driving are decades old and have severe limitations.

The side view mirrors currently in use offer a very limited field of view of the road and therefore are plagued by hazardous blind spots, which can be particularly problematic for certain vehicles. A driver who turns his/her head back to check the blind spots may be distracted from full attention on the road ahead. Older drivers may not be able to do this check very well or quickly, compared with their younger cohorts. Shorter drivers may have their visibility impaired by the seats in the car, due to their lower vantage point in the driver's seat.

Additionally, many of today's vehicles have high rear quarters, which improve aerodynamics, but also further impair visibility. The rear view mirror offers only a small and restricted view out the back windshield, and the view from this mirror and the side view mirrors are not combined.

Current back up and other rear cameras are mounted on the very rear of the vehicle and typically have a fisheye lens for maximum field of view, while depth of field is generally significantly restricted.

In addition, current blind spot warning systems are generally only efficient at sensing what is to the immediate side of the vehicle at that moment, but will not detect objects at a greater distance down the road to the rear of the vehicle, and not what is two lanes over.

As such, considering the foregoing, it may be appreciated that there continues to be a need for novel and improved devices and methods for eliminating hazardous blind spots endemic to most vehicles.

### SUMMARY OF THE INVENTION

The foregoing needs are met, to a great extent, by the present invention, wherein in aspects of this invention, enhancements are provided to the existing model of automotive rearview systems, devices and methods.

An aspect of the present invention describes a system wherein cameras are mounted on top sides and rear of a vehicle, tilted outward and downward to produce a vastly improved combined panoramic view of the road to the side and rear of the vehicle. This elevated vantage point, provides a view that minimizes or completely eliminates blind spots, and furthermore this view will enhance awareness of other vehicles position and enable better sense of movement even two or more lanes over.

In an aspect, a panoramic view system for eliminating blind spots in a vehicle, can include
a) two or more video cameras; and
b) a panoramic screen;
such that the panoramic screen can show a video stream that combines video streams from the video cameras, whereby a driver can view a panoramic video stream of the rear-view vehicle surroundings without any blind spots.

In a related aspect, in addition to eliminating blind spots, the panoramic view system, can allow a driver to view an integrated image of the vehicle surroundings, thereby eliminating a need for the driver to mentally stitch together rear, left and right side views.

In a related aspect the video cameras can include two front side mounted cameras and a rear center camera.

In a related aspect the panoramic screen can display a combined image such that for three panoramic screens, the combined video stream is formed as a combination of video streams from the video cameras, wherein a rightmost border of a first video stream is matched with a leftmost border of a second individual video stream, and so on for additional individual video streams, whereby the panoramic video stream contains all of the content of the individual video streams.

In a related aspect, the panoramic screen can be mounted in the standard position for a traditional rear view mirror.

In a related aspect, the video cameras can further comprise video cameras mounted in such a way as to enable viewing of vehicle wheels and proximity to roadside curbing.

In a related aspect, the panoramic view system can further include transformations of a combined video stream, which can include night vision enhancements.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram illustrating a panoramic view system, according to an embodiment of the invention.

FIG. 2 is a schematic diagram illustrating an example embodiment of the panoramic view system with three video cameras, according to an embodiment of the invention.

FIG. 3 is a schematic diagram illustrating a panoramic controller, according to an embodiment of the invention.

FIG. 4 is a flow chart illustrating an automotive panoramic view method or process, according to an embodiment of the invention.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

In an embodiment, video cameras with high frame rate to capture video in real time can be positioned on the roof and/or sides of a vehicle, in a configuration designed to capture a maximum view of the road to each side and the rear of the vehicle. The view from each camera can be merged to capture a panoramic view of the vehicle environment, covering each side of the vehicle and the rear. This merged image can be displayed on the dashboard or rearview mirror for the driver.

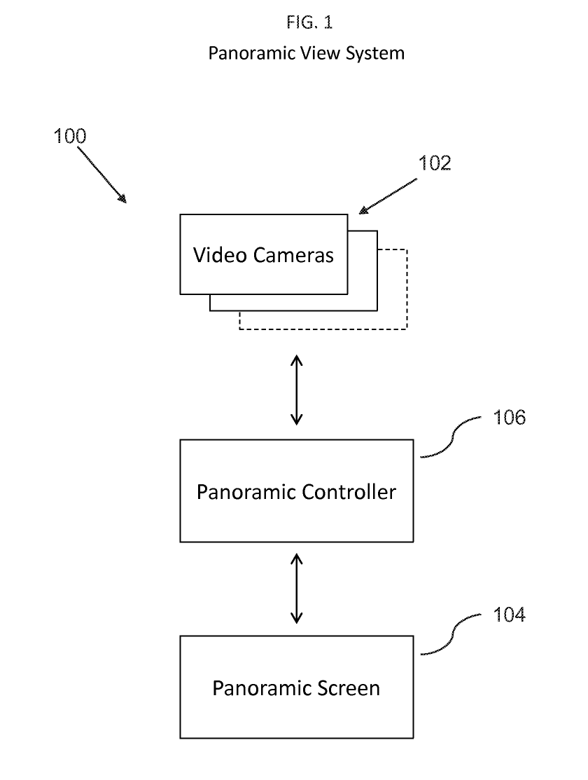

In the following we describe the structure of an embodiment in the form of a panoramic view system with reference to FIG. 1, in such manner that like reference numerals refer to like components throughout; a convention that we shall employ for the remainder of this specification.

In an embodiment, a panoramic view system 100 for eliminating blind spots in a vehicle, can comprise:
a. At least two video cameras 102;
b. A panoramic screen 104;
c. A panoramic controller 106;
Wherein the panoramic screen 104 shows a video stream that combines video streams from the video cameras 102; wherein video streams from the video cameras 102 are received by the panoramic controller 106, which can combine the individual video streams to form a combined video stream, which can be displayed on the panoramic screen 104.

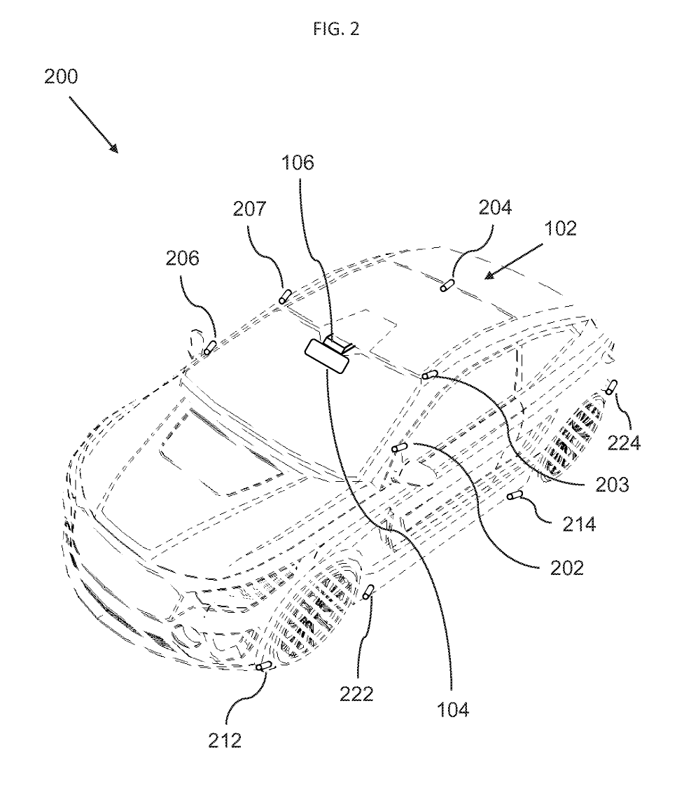

FIG. 2 shows an example embodiment with 3 video cameras 102; comprised of:
a. A front right side panoramic video camera 202;
b. A rear center panoramic camera 204; and a
c. Front left side panoramic video camera 206;

Further, FIG. 2 shows the panoramic controller 106 positioned in the normal position for a rear-view mirror, and the panoramic controller 106 adjacently positioned in a center overhead console. In such an embodiment, the panoramic controller 106 may communicate with the video cameras 102 via a wireless connection.

In various embodiments, the panoramic controller 106 can be positioned in a plurality of different locations in a vehicle, which can include the engine compartment, an overhead console, a center console, a glove compartment, etc.

In related embodiments, the front left and right side panoramic video cameras 202 206 can be configured in a plurality of locations. FIG. 2 shows example alternative positions 203 207.

In a related embodiment of the panoramic view system 100, the video cameras 102 can further comprise:
a. curb mounted video cameras; which can further comprise:
   i. a front right curb mounted video camera 212;
   ii. a rear right curb mounted video camera 214;
   iii. a front left curb mounted video camera;
   iv. a rear left curb mounted video camera;
Wherein the panoramic screen 104 can show a video stream that combines video streams from the curb mounted video cameras 102; wherein video streams from the video cameras 102 are received by the panoramic controller 106, which can combine the individual video streams to form a combined video stream, which can be displayed on the panoramic screen 104. The curb mounted video cameras are shown rear facing in this embodiment.

In a related alternative embodiment of the panoramic view system 100, the video cameras 102 can further comprise:
a. Forward facing curb mounted video cameras; which can further comprise:
   i. a front right forward facing curb mounted video camera 222;
   ii. a rear right forward facing curb mounted video camera 224;
   iii. a front left curb mounted video camera;
   iv. a rear left curb mounted video camera;
Wherein the panoramic screen 104 can show a video stream that combines video streams from the forward facing curb mounted video cameras 102; wherein video streams from the video cameras 102 are received by the panoramic controller 106, which can combine the individual video streams to form a combined video stream, which can be displayed on the panoramic screen 104. The forward facing curb mounted video cameras can provide a more natural viewing angle for a driver during navigation of a parking maneuver.

In a further related embodiment, the panoramic controller 106 can display a dual video stream on the panoramic video screen 104 with the combined panoramic video stream displayed together with the combined curb video stream. The two video streams can be shown side-by-side or top-bottom, or in a picture in picture configuration.

In a yet further related embodiment, the combined curb video stream can be displayed only when the vehicle is travelling below a pre-determined speed. This can for example be such that the pre-determined speed is below 5 miles per hour, which can indicate the vehicle may be prepared for parking, whereby the combined curb video stream can assist a driver during maneuvering in a parking lot and/or during parking, to avoid curb damage to tires and/or wheels, or even the vehicle underside in situations where there is risk of driving over very high curbing.

In another further related embodiment, the combined curb video stream can further show path lines, which can show a projection of the tire path, for example in order to show if/where the tires will collide with the roadside curb.

In a further example embodiment, for large commercial trucks with 40′-53′ trailers, a combined curb video stream from all axle zones, along with display of the projected paths, can be very beneficial to help a truck driver maneuver in tight spots and avoid tipping of the trailer, caused by traversing a high curb/median.

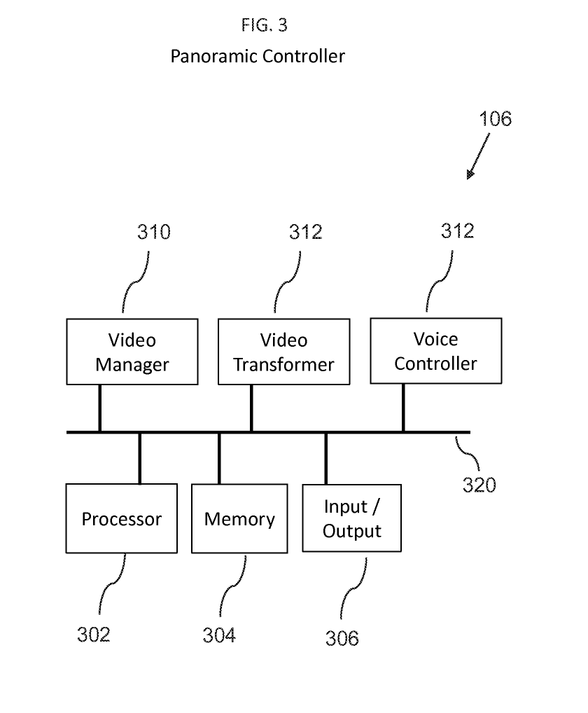

In an embodiment, illustrated in FIG. 3, a panoramic controller 106 can comprise:
a. A processor 302;
b. A non-transitory memory 304;
c. An input/output 306;
d. A video manager 310;
e. Wherein the video manager 310, can receive several video streams via the input/output 306, and can combine the video streams, such that a combined video stream can be output via the input/output 306.

In related embodiments, the video manager 310 can combine images by:
a. Creating a panoramic video stream as a combination of individual panoramic video streams, such that a rightmost border of a first individual video stream is aligned with a leftmost border of a second individual video stream, and further if applicable, the rightmost border of the second individual video stream is aligned with the leftmost border of a third video stream, and so on for additional individual video streams, such that the panoramic video stream contains all of the content of the individual video streams. This embodiment requires that video cameras 102 are properly oriented so that there is no overlap between the images received by each individual video camera 102, and can for example be suitable for an OEM installation, or a carefully calibrated aftermarket installation.
b. Creating a panoramic video stream as a manually aligned combination of individual video streams, such that a right border of a first individual video stream, can be selected by a user, such that it is aligned with a left border of a second individual video stream, and further if applicable, a selected right border of the second individual video stream is aligned with a selected left border of a third video stream, and so on for additional individual video streams, such that the panoramic video stream contains all of the non-overlapping content of the individual video streams. This embodiment can for example be suitable for aftermarket installation since it is less stringent with respect to orientation of the video cameras 102, which can have an overlap of areas covered, but do need to connect the full panoramic view area.
c. Creating a panoramic video stream as an automatically aligned combination of individual video streams, such that a right border of a first individual video stream, is calculated by the video manager 310, such that it matches with a left border of a second individual video stream, and further if applicable, a calculated right border of the second individual video stream is matched with a calculated left border of a third video stream, and so on for additional individual video streams, such that the panoramic video stream contains all of the non-overlapping content of the individual video streams.
   This embodiment can also be suitable for aftermarket installation since it is similarly less stringent with respect to orientation of the video cameras 102, which can have an overlap of areas covered, but do need to connect the full panoramic view area.
   The automatic calculating of matching borders can use well-known video matching algorithms, such as for example, provided by OpenCV and Echoprint libraries.

In related embodiments, the panoramic screen 104 can be mounted in a plurality of locations allowing unrestricted viewing by the driver, including:
a. In the instrument cluster in front of the driver;
b. In the normal center top position for a rear-view mirror;
c. On the left side of the instrument cluster;
d. Above the instrument cluster;
e. In the center of the dashboard
f. On the top of the dashboard, projecting a heads-up display image on the inside of the windshield in front of the driver.

In a related embodiment, the panoramic controller 106 can further include a video transformer, which can perform transformations of a combined video stream, which can include:
a. Night vision enhancement, which can expand the dynamic range of underexposed areas of the combined video stream, and compress the dynamic range of overexposed areas of the combined video stream, whereby the video stream can show more detail in darker areas and reduce areas of overexposure, for example resulting from headlights from other vehicles;
b. HDR transformation, using well known methods from high dynamic range transformation of video images;
c. Motion detection, wherein the video transformer can identify other vehicles or objects entering the surrounding, by identifying areas of the combined video stream, which are moving closer to the vehicle. Motion detection can utilize well-known algorithms for motion detection in video streams, such as algorithms using functions in the OpenCV library, including for example use of calcOpticalFlowPyrLK( ) and related API methods;
d. Zoom, wherein the video transformer can perform a digital or analog zoom function on a selected part of the combined video stream.

In a related embodiment, the video cameras 102 can be retractable such that the video cameras 102 can be protected from the environment in a retracted position. This can further include closing a shutter in front of a video camera when it is in the retracted mode. The retraction function can be operated via an electric servomotor, and can be controlled via the video manager 310 of the panoramic controller 106.

In a related embodiment, the video cameras 102, can be remote controllable, such that the video cameras 102 can be redirected or angled, for example in order to provide an improved view for a specific driving situation.

In a related embodiment, functions of the panoramic view system 100 can be controlled with voice commands via a voice recognition function, such that the panoramic controller 106 is configured with voice recognition functions via a voice controller component 312. The voice recognition function can be configured via application of well-known voice recognition technologies.

In related embodiments, the panoramic view system 100 can enable improvement of vehicle aerodynamic performance and fuel economy, by eliminating the need for traditional side mirrors, which typically generate a significant aerodynamic drag.

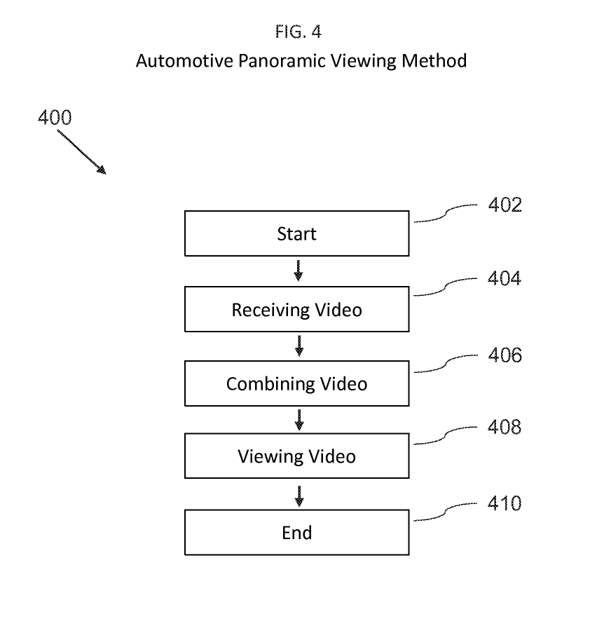

In a related embodiment, as illustrated in FIG. 4, a method for automotive panoramic viewing 400 can comprise:
a. Receiving video, wherein a plurality of video streams are received;
b. Combining video streams, wherein the plurality of video streams are combined into a panoramic video stream;
c. Viewing panoramic video stream, wherein the panoramic video stream can be viewed by a driver of a vehicle.

FIGS. 1, 3, and 4 are block diagrams and flowcharts methods, devices, systems, apparatuses, and computer program products according to various embodiments of the present invention. It shall be understood that each block or step of the block diagram, flowchart and control flow illustrations, and combinations of blocks in the block diagram, flowchart and control flow illustrations, can be implemented by computer program instructions or other means. Although computer program instructions are discussed, an apparatus or system according to the present invention can include other means, such as hardware or some combination of hardware and software, including one or more processors or controllers, for performing the disclosed functions.

In this regard, FIGS. 1 and 3 depict the computer devices of various embodiments, each containing several of the key components of a general-purpose computer by which an embodiment of the present invention may be implemented. Those of ordinary skill in the art will appreciate that a computer can include many components. However, it is not necessary that all of these generally conventional components be shown in order to disclose an illustrative embodiment for practicing the invention. The general-purpose computer can include a processing unit and a system memory, which may include various forms of non-transitory storage media such as random access memory (RAM) and read-only memory (ROM). The computer also may include nonvolatile storage memory, such as a hard disk drive, where additional data can be stored.

It shall be understood that the above-mentioned components of the panoramic view system 100 and the panoramic controller 106 are to be interpreted in the most general manner.

For example, the processor 302 can include a single physical microprocessor or microcontroller, a cluster of processors, a datacenter or a cluster of datacenters, a computing cloud service, and the like.

In a further example, the memory 304 can include various forms of non-transitory storage media, including random access memory and other forms of dynamic storage, and hard disks, hard disk clusters, cloud storage services, and other forms of long-term storage. Similarly, the input/output 306 can each include a plurality of well-known input/output devices, such as screens, keyboards, pointing devices, motion trackers, communication ports, and so forth.

Furthermore, it shall be understood that the panoramic view system 100 and the panoramic controller 106 can each respectively include a number of other components that are well known in the art of general computer devices, and therefore shall not be further described herein. This can include system access to common functions and hardware, such as for example via operating system layers such as Windows, Linux, and similar operating system software, but can also include configurations wherein application services are executing directly on server hardware or via a hardware abstraction layer other than a complete operating system.

An embodiment of the present invention can also include one or more input or output components, such as a mouse, keyboard, monitor, and the like. A display can be provided for viewing text and graphical data, as well as a user interface to allow a user to request specific operations. Furthermore, an embodiment of the present invention may be connected to one or more remote computers via a network interface. The connection may be over a local area network (LAN) wide area network (WAN), and can include all of the necessary circuitry for such a connection.

In related embodiments, the panoramic controller 106 can communicate with the video cameras 102 over a network, which can be a vehicle communication network, such as CAN, SAE 1939, J1708, J1587 or J1850, but can also include the general Internet, a Wide Area Network or a Local Area Network, or another form of communication network, transmitted on wired or wireless connections. Wireless networks can for example include Ethernet, Wi-Fi, Bluetooth, ZigBee, and NFC. The communication can be transferred via a secure, encrypted communication protocol. The wireless network can also include use of wireless induction communication, such as near-field magnetic induction communication.

In related embodiments, the panoramic controller 106 can communicate with the panoramic screen 104 over a network, which can be a vehicle communication network, such as CAN, SAE 1939, J1708, J1587 or J1850, but can also include the general Internet, a Wide Area Network or a Local Area Network, or another form of communication network, transmitted on wired or wireless connections. Wireless networks can for example include Ethernet, Wi-Fi, Bluetooth, ZigBee, and NFC. The communication can be transferred via a secure, encrypted communication protocol. The wireless network can also include use of wireless induction communication, such as near-field magnetic induction communication.

Typically, computer program instructions may be loaded onto the computer or other general-purpose programmable machine to produce a specialized machine, such that the instructions that execute on the computer or other programmable machine create means for implementing the functions specified in the block diagrams, schematic diagrams or flowcharts. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the block diagrams, schematic diagrams or flowcharts.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the block diagram, schematic diagram, flowchart block or step.

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagrams, schematic diagrams or flowcharts, as well as combinations of blocks or steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

The many features and advantages of the invention are apparent from the detailed specification, and thus, it is intended by the appended claims to cover all such features and advantages of the invention, which fall within the true spirit and scope of the invention.

Many such alternative configurations are readily apparent, and should be considered to be fully included in this specification and the claims appended hereto. Accordingly, since numerous modifications and variations will readily occur to those skilled in the art, it is not desired to limit the invention to the exact construction and operation illustrated and described, and thus, all suitable modifications and equivalents may be resorted to, falling within the scope of the invention.

What is claimed is:

1. A panoramic view system for eliminating blind spots in a vehicle, comprising:
a) at least two video cameras; and
b) a panoramic screen;
wherein the panoramic screen shows a panoramic video stream that combines individual video streams from the video cameras, whereby a driver can view a complete video stream of the rear-view vehicle surroundings without any blind spots.

2. The panoramic view system of claim 1, further comprising a panoramic controller, wherein the individual video streams from the video cameras are received by the panoramic controller, wherein the panoramic controller is configured to combine the individual video streams to form a panoramic video stream, which can be displayed on the panoramic screen.

3. The panoramic view system of claim 1, wherein the video cameras are comprised of:
a) a front right side video camera;
b) a rear center camera; and
c) a front left side video camera.

4. The panoramic view system of claim 2, wherein the panoramic controller is configured to combine individual video streams, such that a panoramic video stream is formed as a combination of individual video streams, wherein a rightmost border of a first individual video stream is matched with a leftmost border of a second individual video stream, and so on for additional individual video streams, whereby the panoramic video stream contains all of the content of the individual video streams.

5. The panoramic view system of claim 2, wherein the panoramic controller is configured to combine individual video streams, such that a panoramic video stream is formed as a combination of individual video streams, such that a right border of a first individual video stream can be selected by a user, such that it is matched with a selected left border of a second individual video stream, and further if applicable, a selected right border of the second individual video stream is aligned with a selected left border of a third individual video stream, and so on for additional individual video streams, whereby the panoramic video stream contains all of the non-overlapping content of the individual video streams.

6. The panoramic view system of claim 2, wherein the panoramic controller is configured to combine individual video streams, such that a panoramic video stream is formed as a combination of individual video streams, such that a right border of a first individual video stream, can calculated by the video manager, such that it matches with a left border of a second individual video stream, and further if applicable, a calculated right border of the second individual video stream is matched with a calculated left border of a third individual video stream, and so on for additional individual video streams, such that the individual video stream contains all of the non-overlapping content of the individual video streams.

7. The panoramic view system of claim 1, wherein the panoramic screen is mounted in the normal center top position for a rear-view mirror.

8. The panoramic view system of claim 1, wherein the video cameras further comprise at least one curb mounted video camera,

9. The panoramic view system of claim 8, wherein the at least one curb mounted video camera further comprises curb mounted video cameras:
a) a front right curb mounted video camera; and
b) a front left curb mounted video camera;
wherein the panoramic screen can show a video stream that combines video streams from the curb mounted video cameras; wherein video streams from the curb video cameras are received by the panoramic controller, which can combine the individual curb video streams to form a combined curb video stream, which can be displayed on the panoramic screen;
whereby the combined curb video stream can assist a driver during parking maneuvering to avoid curb damage to tires and wheels.

10. The panoramic view system of claim 9, wherein the combined curb video stream is displayed when the vehicle is travelling below a pre-determined speed.

11. The panoramic view system of claim 2, wherein the panoramic controller further comprises a video transformer, wherein the video transformer is configured to perform a night vision enhancement of the panoramic video stream.

12. The panoramic view system of claim 11, wherein the video transformer is further configured to perform a high dynamic range transformation of the panoramic video stream.

13. The panoramic view system of claim 1, wherein the video cameras are configured to be retractable.

14. The panoramic view system of claim 2, wherein the panoramic controller further comprises a voice controller, wherein the voice controller is configured to control functions of the panoramic view system via voice commands.

15. A method for automotive panoramic viewing for eliminating blind spots in a vehicle, comprising:
a) Receiving video, wherein a plurality of individual video streams are received;
b) Combining video streams, wherein the plurality of individual video streams are combined into a panoramic video stream;
c) Viewing panoramic video stream, wherein the panoramic video stream can be viewed by a driver of the vehicle.

16. The method for automotive panoramic viewing of claim 15, wherein the plurality of video streams comprises three video streams, wherein the video streams are received from respectively:
a) a front right side video camera;
b) a rear center camera; and
c) a front left side video camera.

17. The method for automotive panoramic viewing of claim 15, wherein the step of combining video streams is adapted to form the panoramic video stream as a combination of individual video streams, wherein a rightmost border of a first individual video stream is matched with a leftmost border of a second individual video stream, and so on for additional individual video streams, whereby the panoramic video stream contains all of the content of the individual video streams.

18. The method for automotive panoramic viewing of claim 15, wherein the step of combining video streams is adapted to form the panoramic video stream as a combination of individual video streams, such that a right border of a first individual video stream, can be selected by a user, such that it is matched with a selected left border of a second individual video stream, and further if applicable, a selected right border of the second individual video stream is matched with a selected left border of a third video stream, and so on for additional individual video streams, whereby the panoramic video stream contains all of the non-overlapping content of the individual video streams.

19. The method for automotive panoramic viewing of claim 15, wherein the step of combining video streams is adapted to form the panoramic video stream as a combination of individual video streams, such that a right border of a first individual video stream, is calculated such that it matches with a left border of a second individual video stream, and further if applicable, a calculated right border of the second individual video stream is matched with a calculated left border of a third video stream, and so on for additional individual video streams, such that the panoramic video stream contains all of the non-overlapping content of the individual video streams.

20. The method for automotive panoramic viewing of claim 15, wherein the panoramic video stream is viewed in the normal top position for a rear-view mirror.
